(19) United States
(12) Patent Application Publication
(10) Pub. No.: US 2023/0319174 A1
(43) Pub. Date: Oct. 5, 2023

(54) Smart wearable solar devices and methods for communication

(71) Applicant: Phyllis Jager, NYC, NY (US)

(72) Inventor: Phyllis Jager, NYC, NY (US)

(21) Appl. No.: 17/333,077

(22) Filed: May 28, 2021

(51) Int. Cl. H04M 1/60; H02J 7/35; H04M 19/08

(52) U.S. Cl. CPC H04M 1/6041; H02J 7/35; H04M 19/08; G10L 13/00

(57) ABSTRACT

This disclosure generally relates to smartphone and communication device which is wireless and rechargeable. The device can be controlled through voice and embedded with software for a number of functionalities. The invention also relates to solar charging and uses natural light for power and functioning. The Artificial Intelligence-based smartphone named Chear can respond to voice commands, access databases through internet connectivity, and create a novel communication stream that informs both the wearer and those around them. The smartphone has a protective covering of rubber and plastic to protect the device from possible damages. The invention can be connected to the World Wide Web (internes). It can perform live streaming for audio and video and complete texting functionality, including reading, writing, and sending messages and e-mails. The device can operate via speakerphone. As a smart gadget, it can access the internet, take voice commands, transfer/exchange/store cloud-based data, which can be transferred to any other device through a USB port. It includes the functionalities of a camera and is GPS enabled.

### BACKGROUND

### Field of the Invention

The present invention relates to an Artificial Intelligence-based hands-free, wireless, wearable, solar-powered, solar chargeable, in-ear smartphone, and solar charging station. The invention is a small portable communication device with all functionalities of mobile phone, audio and music devices, which can be controlled through voice and embedded with software for many functionalities. The invention also relates to the chargeable device, which is chargeable through solar light with an option of charging through an AC port. The invention is the broad category of smartphones and a complete functioning smart communication device in a pattern of earphones and built-in microphones. The invention can be categorized as wireless smart tech gadgets and devices capable of charging through solar light and comes in with a solar docking and charging station.

Aspects of the present invention relate more particularly to using the trend—having all-in-one features for a small gadget. The invention supports all audio, video, and communication facilities and keeps its uniqueness as a complete smartphone embedded with all other features. The invention can recharge solar light and take its power from natural light. In short, the invention is in the shape of a wireless earphone, which can be deemed as “Emotional Mirror” technology—working on sensors and voice-based commands. The invention is an addition to a fast and healthy lifestyle, being an addition to the smartphone and audio technology.

### Description of the Related Art

The term ‘smartphone’ refers to a multi-functional mobile phone handset that packs everything from a camera and web browser to a highdensity display. Other key features of a smartphone include masses of storage space and microSD card slots to upgrade further and intuitive touchscreen user interfaces so you can access all the great functions of the handset quickly and easily. The use of smartphones is unlimited in today's technological world. The use originally started from transistors and Walkman has extended to cell phones, PDAs, TVs, MP3, Ipad/phones and now not limited to internet connectivity enabled with software to act as a player.

A regular pattern of smartphones is the ones that come in a phone shape irrespective of the size. Consumers use wireless earphones or Bluetooth to operate them without picking them in hand by placing wireless earphones or Bluetooth devices that plug into the user's ear canal. Users of one of these devices (earphones/Bluetooth) would plug the headset into the device to privately listen to the audio signals output from the device or to listen without disturbing others around the user. The conventional headsets used to have one or two earphones and may include a microphone for applications where user audio input is needed, such as a telephone. A user can, and often do wear the headset when listening to an audio signal, and even when not. The traditional smartphone and mobile communication sets were usually large and wireless, did not have internet connectivity, and worked on voice commands.

By looking at prior art, multiple advancements have been seen in solar energy usage to provide users with enhanced convenience. For instance, a solar-powered mobile phone bearing U.S. Pat. No. 9,048,927B2 is issued to GlynnTech Inc. The patent implies a solar-powered cell phone includes a cell phone main housing including conventional cell phone components including; a rechargeable power storage unit connected to cell phone internal mechanisms; and at least two solar cell panels connected to the rechargeable power storage unit, wherein at least one of the at least two solar cell panels is movably connected to the main housing and has a first position, being a closed position for storage, and having a second position, being an open position for charging.

Another patent on a wireless solar entertainment system bearing U.S. Pat. No. 5,551,065A is issued to David Honore. The invention comprises a consumer electronics entertainment system with a transmitter and a wireless headphone receiver matching frequency reception. It is particularly adapted for joggers, runners, walkers, picnickers, sunbathers, or other mobile users. The invention entails a transmission integrated the solar-powered cassette radio or CD ROM player or other portable consumer electronics entertainment device with a built-in low range low power transmitter and wireless headphones that also operate on solar power with an automatically solar-charged backup battery that never needs replacement.

A Solar-Powered Mobile Telephone bearing US patent 2,005,0282591A1 is issued to Mari Shaff. The patent discusses a mobile telephone apparatus is disclosed in which a solar power source is used to supplement battery power. A solar cell array is positioned on the surface of the telephone and supplies electric current to the telephone. A preferred embodiment of the present invention is equipped with speech recognition software that allows the user to issue commands (such as dialing the telephone) verbally to the telephone. In addition, this speech recognition may be used to operate an integrated AM/FM broadcast radio to allow the telephone to double as a radio. In an alternative embodiment, the solar mobile telephone is integrated into a headset to allow convenient hands-free operation.

Another patent on Portable phone holder and solar charger bearing US patent 2,010,0317413A1 is issued to Qing Song Tan. The patent implies a portable phone holder and solar charger for holding and charging a portable electronic device. The portable phone holder and charger include a cradle portion that cradles a portable electronic device, a plug or electrical contacts that make electrical connection with the portable electronic device, a base portion, a battery and recharging electronic circuitry, a solar panel, and a hinge that pivotally connects the cradle portion and the base portion. The plug is adapted to engage with the portable electronic device and extends from the hinge, and moves in concert along with the cradle portion when the base and cradle portions are pivoted relative to each other. The cradle portion retains the portable electronic device connected with the electrical engagement. The hinge preferably provides click stops at a plurality of positions of pivoting of the cradle portion relative to the base portion. The solar panel allows for recharging of the battery in the base portion to be recharged and the connected portable electronic device to be recharged.

A Solar cell phone bearing US patent 2,013,0040707A1 is issued to Theoda Metcalf. The patent implies that a solar cell phone includes a keypad, a display screen, other electronic components, and a rechargeable battery. A diode switch within the housing is electrically connected to the rechargeable battery. A plurality of solar panels is mounted to the housing and electrically connected to the diode switch. The diode switch will allow the solar panels to supply electrical power to the rechargeable battery. An auxiliary battery within the housing receives electrical power from the solar panels. The auxiliary battery will store the electrical power to recharge the rechargeable battery when the diode switch is in a non-operative position so that the rechargeable battery will continue to operate the keypad, the display screen, and the other electronic components within the housing.

Another patent on solar cell phones bearing U.S. Pat. No. 9,680,1892 is issued to Theoda MetCaf. The patent discusses a solar cell phone, including a keypad, a display screen, other electronic components, and a rechargeable battery. A diode switch within the housing is electrically connected to the rechargeable battery. A plurality of solar panels is mounted to the housing and electrically connected to the diode switch. The diode switch will allow the solar panels to supply electrical power to the rechargeable battery. An auxiliary battery within the housing receives electrical power from the solar panels. The auxiliary battery will store the electrical power to recharge the rechargeable battery when the diode switch is in a non-operative position so that the rechargeable battery will continue to operate the keypad, the display screen, and the other electronic components within the housing.

A Solar-powered cell phone charging device bearing US patent 2,017,0163077A is issued to Ita May Hill. The patent discusses a solar-powered cell phone charging device has been disclosed that provides a cell phone case with integrated solar panels and a power connector coupled to the case for connecting to a cell phone charging port, allowing the user to charge a cell phone by using solar power. In an increasingly digital age, with further reliance on cell phones for almost every aspect of daily life, there is a need to charge a cell phone portably. Further, there exists a need to perform this charging through renewable energy sources, rather than non-renewable sources, due to the cost and deletion of non-renewable energy sources. Finally, there is a need to portably charge cell phones without being tethered to a wall or a portable battery pack, which must be independently charged through traditional non-renewable energy sources.

In the prior art, multiple inventions have been proposed to bring advancement and enhanced utility regarding advancements in miniature smartphones. Furthermore, these systems' utilization in daily life is quite cumbersome and non-effective. Also, the features of these utility systems are quite limited.

In contrast, it is an object of the invention to create an Artificial Intelligence-based smartphone that can recognize voice commands and analyze them, then perform the task and report back they can also shut down when not in use. It includes manual and voice-activated remote sensors, which can be used in place of the ‘wake word.’

None of the previous inventions and patents, taken either singly or in combination, describes the instant invention as claimed. Hence, the inventor of the present invention proposes to resolve and surmount existent technical difficulties to eliminate the shortcomings mentioned earlier of the prior art.

### SUMMARY

In light of the disadvantages of the prior art, the following summary is provided to facilitate an understanding of some of the innovative features unique to the present invention. It is not intended to be a complete description. A full appreciation of the various aspects of the invention can be gained by taking the entire specification, claims, drawings, and abstract as a whole.

Considering the advances in technology, the primary objective of the invention relates to the latest trend of miniaturizing, embedded with the latest software, having all in one feature, use of natural resources for charging and giving all functionalities of a typical smartphone in the share of a small wireless gadget with a look of a wireless earphone. The invention, which in actuality is a smartphone and complete communication device, can respond to everything from an individual's emotional state to their interactions with others with light, color, and opacity; these adaptive materials create a novel communication stream that informs both the wearer and those around them.

The invention's objective is also to provide a smartphone named “Chear” that can recognize voice commands and analyze them, then perform the task and report back they can also shut down when not in use. It includes manual and voice-activated remote sensors, which can be used in place of the ‘wake word.’

The functionality of the Chear is the Artificial Intelligence-based wireless smartphone is very diverse. The invention's objective is to provide a unique styled smartphone, which is hands-free, wireless, wearable, solar-powered, solar chargeable, a smartphone that goes in the ear similarly to an earbud. Despite having a unique shape and charging capacity with wireless and wearable features, it can perform all functions of a complete cell phone and a communication device. It also has all features of an audio-video player.

The invention's further objective is to provide an Artificial Intelligence-based device connected to the World Wide Web (internet) and perform live streaming for audio and video. The complete functionality of texting includes reading, writing, and sending messages and e-mails. The device can operate via speakerphone. As a smart gadget, it can access the internet, take voice commands, transfer/exchange/store cloud-based data, which can be transferred to any other device through a USB port.

It is also the objective of the invention to include the functionalities of the camera and is GPS enabled. All possible skills for consumer convenience are embedded, giving the consumer all in one capability wireless smartphone, which can be worn as earphones.

This summary is provided merely to summarize some example embodiments to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the detailed description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification and serve to illustrate further embodiments of concepts that include the claimed invention and explain various principles and advantages of those embodiments.

FIG. 1 shows an upper view of one embodiment of the wireless, wearable, and rechargeable smartphone. It shows the earbud portion is to be worn in-ear. It also shows the phone's estimated size compared to the earpiece. It shows its sleek round design with its earpiece for two-way communication.

FIG. 2 shows the front view of the smartphone, the part that would be inserted in the ear, and a part that would emit sound. It shows the design and ear resting part of the device.

FIG. 3 shows the smartphone's side-view, giving a closer view of the screen display. It gives the visibility and idea of the screen size and visibility of different functions. The figure gives the view of a phone with the phone indications.

FIG. 4 shows the same side view with a different display. The display indicates an incoming call answered via voice connectivity or manual touching. The screen and image give a clear idea of the invention, which is like an earphone in shape but a smartphone with multiple features.

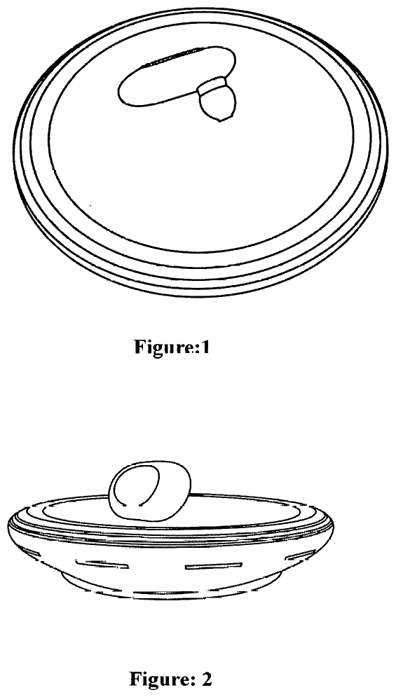

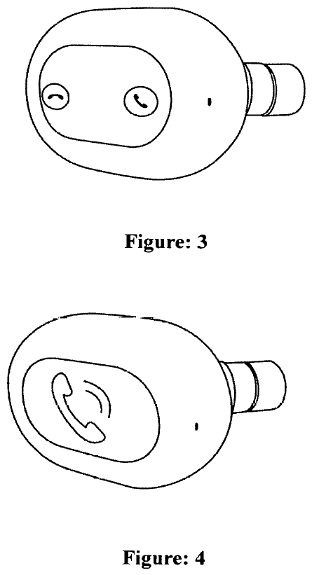

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The Abstract of the Disclosure is provided to allow the reader to ascertain the technical disclosure's nature quickly. It is submitted with the understanding that it will not be used to interpret or limit the scope or meaning of the claims. In addition, in the preceding Detailed Description, it can be seen that various features are grouped in various embodiments to streamline the disclosure. This method of disclosure is not to be interpreted as reflecting an intention that the claimed embodiments require more features than are expressly recited in each claim. Instead, as the following claims reflect, the inventive subject matter lies in less than all features of a single disclosed embodiment. Thus the following claims are hereby incorporated into the Detailed Description, with each claim standing on its own as a separately claimed subject matter.

### DETAILED DESCRIPTION

Detailed descriptions of the preferred embodiment are provided herein. However, it is to be understood that the present invention may be embodied in various forms. Therefore, specific details disclosed herein are not to be interpreted as limiting but rather as a basis for the claims and a representative basis for teaching one skilled in the art to employ the present invention in virtually any appropriately detailed system, structure, or manner.

In light of the disadvantages of the prior art, the following summary is provided to facilitate an understanding of some of the innovative features unique to the present invention. It is not intended to be a complete description. A full appreciation of the various aspects of the invention can be gained by taking the entire specification, claims, drawings, and abstract as a whole.

According to a first embodiment, the Artificial Intelligence-based smartphone, invented, is wireless and does not require connectivity through wires. It can work as a Bluetooth device but is not Bluetooth. Internet connectivity of the smartphone (Chear) makes it effective in handling. The smartphone is rechargeable through solar light using natural resources and is not electricity-dependent in the same context. It can charge when it faces the sun or natural light other than its solar docking and charging station. The device lights up when it gets full charge as an indication.

As further embodiments of the invention, the wireless smartphone can use natural light to power it up. Its functionality would never be underperformed in the presence of natural light. The solar charging would enable its functioning even at night time.

As per additional embodiment, the newly invented wireless smartphones can connect to any device and are not limited to specific players. It is wireless, so it is wire-free. It can play music from multiple devices and different software platforms through connectivity. It can connect to smartphones, smart devices, and different IOS systems to play music or audio by connecting to them. It can connect to a number of apps and music players other than computer and software-enabled devices. It can connect to the internet for live streaming; web browsing, mails, GPS, traffic maps, and connect to remote devices.

As per its additional embodiments, the assembly is GPS enabled and can perform automated voice directions in different turns and modes. The GPS feature will connect to live traffic, maps, satellites, and servers for data streaming and downloading. The smartphone can recognize voice commands, analyze them, then perform the task and report back; they can also shut down when not used. The invention has this unique feature of working on voice command through micro-controlled chip and software.

As per its further embodiments, the assembly is wireless, and the wearable smartphone has a camera for taking snaps and making videos. The device, through its camera, has the audio-video communications ability for teleconferencing and video calls. It also supports all social media apps for full functionality.

The invention requires internet connectivity to work. The voice recognition capability is based on web services and enabled through the voice platform. It is software-enabled, its functioning is linked with the server through. World Wide Web. The device will even work if the signal strength of the internet is low. The invention gives good performance even at low latency, where factors like processing time, streaming, geo-disturbed service endpoints do not hinder the performance.

As per its further embodiments, the device is capable of giving news and weather forecast from a variety of sources once it is connected to the internet. It can synchronize with radio stations to give updates through internet connectivity. In the same context, earphones can play music directly from the Music accounts and have built-in support for streaming music services. The device provides support to thermostats and can play music from streaming services like Apple and Google Play. It can synchronize through a phone or tablet for playing the music if required.

It supports activities like listening to audiobooks and other online audio devices through streaming. The device operates through internet connectivity and connects through a server, and it can maintain voice-controlled alarms, timers, shopping and to-do lists, and access online articles. The latest wireless smartphone responds to questions about items by connecting to the internet and other related databases and devices.

The invention, as per its additional embodiments, is a wearable mobile phone and acts as a personal media player and mini communicator has the capability of real-time two-way and multi-feed wireless voice, data and audio-video streaming, telecommunications, and teleconferencing, coordinated applications, and shared functionality between one or more wirelessly networked mobile devices or other paired or networked wired or wireless devices and optimized device and data management over multiple wired and wireless network connections.

An extensive collection of self-service APIs, Apps, tools, documentation, and code samples are available to facilitate the self-service mentioned above. The software can be updated, and more features can be added to customize the functionalities. The same can be used through connectivity to the internet and other devices.

As per its additional embodiments, the device is internet-connected and operates through server-based software; new versions and software releases will fix bugs and include enhanced functionality over time. The device will work on the principle of artificial intelligence, and the device system can be updated through software and cloud networking once connected to the internet.

It's a hot spot and wireless router supporting direct connect multi-device ad-hoc virtual private networking (VPN). Can use operating systems, including Fire OS. Apart from this has the feature of WiFi tethering, enabling it to connect to a WiFi hotspot on a mobile device, including public WiFi. The invention also features an option to plug into a wall charger or USB outlet. Last but not least, the device includes 3d Spatial perception.

As per its further embodiments, the assembly operates via voice command and voice vibration. The smartphone invention lets you talk back with an “ear microphone” that transmits your voice by picking up the vibrations in your ear canal. The earphone has built-in intelligence to choose among available network protocols while supporting a variety of onboard and remote operational controls. This device does not need to sync with another instrument, headset, or handset of any kind. It is, by all means, a wireless solar cellular communication device with an ingenious solar charging station.

Chear the smartphone has a solar-powered docking/charging station, with venting that's approximately five inches around and an inch and a half in height. The Charging Station has a color-changing LED light system and the top edge framework that circumvolves until the device is fully charged, whereas it then goes to sleep. The charging station is comprised of solar technology around its top, sidewall, and bottom panel. A cyclonic internal system generates, converts, and transfers power to maintain continuous energy until the device is fully charged.

The wearable smartphone “Chear” can allow phone calls wirelessly and is a wireless smartphone (not Bluetooth connected) conceived with a solar panel screen mounted on the top face. Power is drawn from natural light through the solar panel to recharge its internal battery. The smartphone as an alternative also can recharge through an AC outlet. Chear uses a nonpolluting process to recharge its internal battery through a photovoltaic film located on top of the charging station and the ear chip.

As per its additional embodiments, a pin-sized pointer stored in Chear's side shell will deliver a holographic display allowing easy viewing without the use of glasses. This facilitation is provided to overcome the small design. To facilitate the use to view the things in large mode and more clearly as to their suitability, the pointer is provided along with the device for holographic displays.

The design factor of the smartphone is in accordance to protect the small device from all shocks and damages. The smartphone “Chear” has a combined blend of plastic and rubber will produce a protective shell that will absorb shock and protect the Chear's screen. The invention comes with a complete protection cover to maximize screen protection against all possible follies of breaking or damage.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to it without departing from its spirit. Therefore, it is not intended that the scope of the invention be limited to the specific embodiment illustrated and described. Instead, it is intended that the appended claims and their equivalents determine the scope of this invention.

1. An Artificial Intelligence-based, hands-free, wireless, wearable, solar-powered, solar chargeable, in-ear smartphone accompanies by a solar charging station comprising:
a smart-phone with LED lights that charges through solar light and uses natural light to power it up and function;
customizable through software update;
features enhanced through apps and servers;
configured to perform multiple functions by connecting to internet and operate through a server, where the smart-phone does not have software storage, but works on artificial intelligence and cloud computing network;
a manually and voice-activated wireless smart-phone;
recognition of voice commands, then analyze them, then perform the task and report back;
use of natural life like voices result from speech-unit technology through sophisticated natural language processing (NLP) algorithms built into a text-to-speech (TTS) engine;
Intelligence platform that lies in the cloud, significant functional enhancements made without updating the software version it is running and use operating systems including Fire OS, Wi-Fi tethering and may include 3d Spatial perception.
